(19) United States
(12) Patent Application Publication
(10) Pub. No.: US 2012/0044529 A1
(43) Pub. Date: Feb. 23, 2012

(54) PROCESSING ORDER DETERMINING APPARATUS, PROCESSING ORDER DETERMINING METHOD, AND NON-TRANSITORY COMPUTER-READABLE RECORDING MEDIUM ENCODED WITH PROCESSING ORDER DETERMINING PROGRAM

(75) Inventor: Kunihiko SUGIMOTO, Yawata-shi (JP)

(73) Assignee: Konica Minolta Business Technologies, Inc., Tokyo (JP)

(21) Appl. No.: 13/194,573

(22) Filed: Jul. 29, 2011

(30) Foreign Application Priority Data
Aug. 18, 2010 (JP) 2010-182979

(51) Int. Cl. G06K 15/00

(52) U.S. Cl. 358/1.15

(57) ABSTRACT

A processing order determining apparatus for managing delivery deadlines of jobs includes: a setting portion to set, for each of the jobs, two or more process steps, a process step order according to which the two or more process steps are to be executed, operators who are in charge of the respective process steps, and a delivery deadline; a remaining period calculating portion to calculate a remaining period for each of the jobs, on the basis of a period up to the delivery deadline and an expected processing period which is a sum of processing times for uncompleted process steps included therein; a job allocating portion to allocate each of the jobs to an operator who is in charge of a first uncompleted process step included therein; and a processing order determining portion to determine, for each operator, the order of one or more process target jobs in each of which the operator is in charge of a first uncompleted process step, the order being set in ascending order of the remaining period calculated for each of the process target jobs. The processing order determining portion includes a selecting portion to select one of the process target jobs that has not been assigned a rank yet and for which the calculated remaining period is the shortest, a rank assigning portion to assign a rank to the selected process target job, an updating portion to update the remaining period of each of outstanding process target jobs which have not been assigned ranks yet, to a value obtained by subtracting therefrom a process step processing time for the process step which is included in the process target job that has been assigned the rank and which is to be performed by the operator, and a rank changing portion, in the case where the process target jobs that have not been assigned ranks yet include a process target job whose updated remaining period takes a negative value, to assign the same rank as the one that had been assigned to the selected process target job to the process target job whose remaining period takes a negative value, and to cancel the rank that had been assigned to the selected process target job.

This application is based on Japanese Patent Application No. 2010-182979 filed with Japan Patent Office on Aug. 18, 2010, the entire content of which is hereby incorporated by reference.

### BACKGROUND OF THE INVENTION

1. Field of the Invention

The present invention relates to a processing order determining apparatus, a processing order determining method, and a non-transitory computer-readable recording medium encoded with a processing order determining program. More particularly, the present invention relates to a processing order determining apparatus which determines the processing order of a plurality of jobs to be processed in a plurality of process steps, and a processing order determining method and a non-transitory computer-readable recording medium encoded with a processing order determining program which are carried out by the processing order determining apparatus.

2. Description of the Related Art

There is a service for printing and bookbinding on the basis of print data obtained from a customer. To provide this service, a job made up of a plurality of processes including editing of the print data, printing, and bookbinding is divided and distributed to a plurality of operators so as to be carried out thereby. In order to distribute a plurality of jobs made up of a plurality of processes to a plurality of operators for execution thereof, it will be efficient to create a schedule in which the jobs are assigned to the respective operators. Various techniques for creating such schedules are known.

With many of the conventional scheduling techniques, however, jobs are given different priorities before being assigned to operators. Thus, as a result of scheduling, there may be a job that will not meet the delivery deadline, in which case the scheduling needs to be performed again for example by raising the priority of the job that will not meet the delivery deadline.

### SUMMARY OF THE INVENTION

According to an aspect of the present invention, a processing order determining apparatus is for managing delivery deadlines of a plurality of jobs, and includes: a setting portion to set, for each of the plurality of jobs, two or more process steps selected from among a plurality of process steps, a process step order according to which the two or more process steps are to be executed, operators who are in charge of the respective ones of the two or more process steps, and a delivery deadline; a remaining period calculating portion to calculate a remaining period for each of the plurality of jobs, on the basis of a period up to the delivery deadline and an expected processing period, the expected processing period being a sum of processing times for uncompleted process steps included therein; a job allocating portion to allocate each of the plurality of jobs to an operator who is in charge of a first uncompleted process step included therein; and a processing order determining portion to determine, for each of a plurality of operators, the order of one or more process target jobs, among the plurality of jobs, in each of which the operator is in charge of a first uncompleted process step included therein, the order being set in ascending order of the remaining period calculated for each of the one or more process target jobs, wherein the processing order determining portion includes a selecting portion to select, from among the one or more process target jobs, a process target job which has not been assigned a rank yet and for which the calculated remaining period is the shortest, a rank assigning portion to assign a rank to the selected process target job, an updating portion to update the remaining period of each of one or more outstanding process target jobs which have not been assigned ranks yet among the one or more process target jobs, to a value obtained by subtracting therefrom a process step processing time for the process step which is included in the process target job that has been assigned the rank and which is to be performed by the operator, and a rank changing portion, in the case where the one or more outstanding process target jobs that have not been assigned ranks yet include a process target job whose remaining period that has been updated by the updating portion takes a negative value, to assign the same rank as the one that had been assigned to the selected process target job to the process target job whose remaining period takes a negative value, and to cancel the rank that had been assigned to the selected process target job.

According to another aspect of the present invention, a processing order determining apparatus is for managing delivery deadlines of a plurality of jobs, and includes: a setting portion to set, for each of the plurality of jobs, two or more process steps selected from among a plurality of process steps, a process step order according to which the two or more process steps are to be executed, operators who are in charge of the respective ones of the two or more process steps, and a delivery deadline; a remaining period calculating portion to calculate a remaining period for each of the plurality of jobs, on the basis of a period up to the delivery deadline and an expected processing period, the expected processing period being a sum of processing times for uncompleted process steps included therein; a job allocating portion to allocate each of the plurality of jobs to an operator who is in charge of a first uncompleted process step included therein; and a processing order determining portion to determine, for each operator, the order of one or more process target jobs, among the plurality of jobs, in each of which the operator is in charge of a first uncompleted process step included therein, the order being set in ascending order of the remaining period calculated for each of the one or more process target jobs; wherein the remaining period calculating portion calculates the remaining period by doubling a processing time for any defective process step for which an occurrence probability that the processing thereof will be repeated is a prescribed value or more.

According to a further aspect of the present invention, a processing order determining method is performed by a computer configured to manage delivery deadlines of a plurality of jobs, the method causing the computer to perform steps of: setting, for each of the plurality of jobs, two or more process steps selected from among a plurality of process steps, a process step order according to which the two or more process steps are to be executed, operators who are in charge of the respective ones of the two or more process steps, and a delivery deadline; calculating a remaining period for each of the plurality of jobs, on the basis of a period up to the delivery deadline and an expected processing period, the expected processing period being a sum of processing times for uncompleted process steps included therein; allocating each of the plurality of jobs to an operator who is in charge of a first uncompleted process step included therein; and determining, for each of a plurality of operators, the order of one or more process target jobs, among the plurality of jobs, in each of which the operator is in charge of a first uncompleted process step included therein, the order being set in ascending order of the remaining period calculated for each of the one or more process target jobs, wherein the determining step includes steps of selecting, from among the one or more process target jobs, a process target job which has not been assigned a rank yet and for which the calculated remaining period is the shortest, assigning a rank to the selected process target job, updating the remaining period of each of one or more outstanding process target jobs which have not been assigned ranks yet among the one or more process target jobs, to a value obtained by subtracting therefrom a process step processing time for the process step which is included in the process target job that has been assigned the rank and which is to be performed by the operator, and in the case where the one or more outstanding process target jobs that have not been assigned ranks yet include a process target job whose remaining period that has been updated in the updating step takes a negative value, assigning the same rank as the one that had been assigned to the selected process target job to the process target job whose remaining period takes a negative value, and cancelling the rank that had been assigned to the selected process target job.

According to a still further aspect of the present invention, a processing order determining method is performed by a computer configured to manage delivery deadlines of a plurality of jobs, the method causing the computer to perform steps of: setting, for each of the plurality of jobs, two or more process steps selected from among a plurality of process steps, a process step order according to which the two or more process steps are to be executed, operators who are in charge of the respective ones of the two or more process steps, and a delivery deadline; calculating a remaining period for each of the plurality of jobs, on the basis of a period up to the delivery deadline and an expected processing period, the expected processing period being a sum of processing times for uncompleted process steps included therein; allocating each of the plurality of jobs to an operator who is in charge of a first uncompleted process step included therein; and determining, for each operator, the order of one or more process target jobs, among the plurality of jobs, in each of which the operator is in charge of a first uncompleted process step included therein, the order being set in ascending order of the remaining period calculated for each of the one or more process target jobs; wherein the remaining period calculating step includes a step of calculating the remaining period by doubling a processing time for any defective process step for which an occurrence probability that the processing thereof will be repeated is a prescribed value or more.

According to yet another aspect of the present invention, there is provided a non-transitory computer-readable recording medium encoded with a processing order determining program performed by a computer configured to manage delivery deadlines of a plurality of jobs, the program causing the computer to execute processing including steps of: setting, for each of the plurality of jobs, two or more process steps selected from among a plurality of process steps, a process step order according to which the two or more process steps are to be executed, operators who are in charge of the respective ones of the two or more process steps, and a delivery deadline; calculating a remaining period for each of the plurality of jobs, on the basis of a period up to the delivery deadline and an expected processing period, the expected processing period being a sum of processing times for uncompleted process steps included therein; allocating each of the plurality of jobs to an operator who is in charge of a first uncompleted process step included therein; and determining, for each of a plurality of operators, the order of one or more process target jobs, among the plurality of jobs, in each of which the operator is in charge of a first uncompleted process step included therein, the order being set in ascending order of the remaining period calculated for each of the one or more process target jobs, wherein the determining step includes steps of selecting, from among the one or more process target jobs, a process target job which has not been assigned a rank yet and for which the calculated remaining period is the shortest, assigning a rank to the selected process target job, updating the remaining period of each of one or more outstanding process target jobs which have not been assigned ranks yet among the one or more process target jobs, to a value obtained by subtracting therefrom a process step processing time for the process step which is included in the process target job that has been assigned the rank and which is to be performed by the operator, and in the case where the one or more outstanding process target jobs that have not been assigned ranks yet include a process target job whose remaining period that has been updated in the updating step takes a negative value, assigning the same rank as the one that had been assigned to the selected process target job to the process target job whose remaining period takes a negative value, and cancelling the rank that had been assigned to the selected process target job.

According to yet another aspect of the present invention, a non-transitory computer-readable recording medium encoded with a processing order determining program performed by a computer configured to manage delivery deadlines of a plurality of jobs, the program causing the computer to execute processing including steps of setting, for each of the plurality of jobs, two or more process steps selected from among a plurality of process steps, a process step order according to which the two or more process steps are to be executed, operators who are in charge of the respective ones of the two or more process steps, and a delivery deadline; calculating a remaining period for each of the plurality of jobs, on the basis of a period up to the delivery deadline and an expected processing period, the expected processing period being a sum of processing times for uncompleted process steps included therein; allocating each of the plurality of jobs to an operator who is in charge of a first uncompleted process step included therein; and determining, for each operator, the order of one or more process target jobs, among the plurality of jobs, in each of which the operator is in charge of a first uncompleted process step included therein, the order being set in ascending order of the remaining period calculated for each of the one or more process target jobs; wherein the remaining period calculating step includes a step of calculating the remaining period by doubling a processing time for any defective process step for which an occurrence probability that the processing thereof will be repeated is a prescribed value or more.

The foregoing and other features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a workflow system according to an embodiment of the present invention;

FIG. 2 is a block diagram showing an example of the hardware configuration of a server;

FIG. 3 shows an example of a job ticket;

FIG. 4 is a block diagram schematically showing the functions of a CPU included in the server;

FIG. 5 shows an example of an occurrence probability table;

FIG. 6 is a flowchart illustrating an example of the flow of a processing order determining process;

FIG. 7 is a flowchart illustrating an example of the flow of remaining period calculation;

FIG. 8 is a flowchart illustrating an example of the flow of a job allocating process;

FIGS. 9 and 10 show a flowchart illustrating an example of the flow of a rank determination process;

FIGS. 11A to 11C are a first set of diagrams illustrating how the ranks of job tickets are determined;

FIGS. 12A to 12F are a second set of diagrams illustrating how the ranks of job tickets are determined;

FIG. 13 is a block diagram schematically showing the functions of a CPU included in a server according to a modification; and

FIG. 14 is a flowchart illustrating an example of the flow of the remaining period calculation according to the modification.

### DESCRIPTION OF THE PREFERRED EMBODIMENTS

The preferred embodiments of the present invention will be described below in conjunction with the drawings. In the following description, the same or corresponding parts are denoted by the same reference characters. Their names and functions are also the same. Thus, a detailed description thereof will not be repeated.

FIG. 1 schematically shows a workflow system according to an embodiment of the present invention. Referring to FIG. 1, a workflow system 1 includes printers 100 and 101, a server 200 serving as a processing order determining apparatus, and personal computers (hereinafter, referred to as “PCs”) 301 to 305. Printers 100 and 101, server 200, and PCs 301 to 305 are each connected to a network 2.

Network 2 is a local area network (LAN), which is connected via a gateway to the Internet. Network 2 may be connected in a wired or wireless manner. Further, network 2 is not limited to the LAN, but may be a network using the public switched telephone networks (PSTN), a wide area network (WAN), or the Internet.

Server 200, which is a typical computer, has a processing order determining program installed therein. When job tickets are input by an administrator, server 200 determines, for each of a plurality of operators, the order of tasks which the operator should perform, and informs the determined orders to PCs 301 to 305 which are manipulated by the respective operators. Server 200 collects the results of the processing that the operators have performed by manipulating the corresponding PCs 301 to 305, to thereby manage the progress of the jobs for the respective job tickets. Specific processes which are carried out by server 200 will be described later in detail.

Printers 100 and 101 each have an image forming function of forming an image on a recording medium such as a sheet of paper on the basis of print data transmitted from server 200 or one of PCs 301 to 305, and a function of bookbinding the sheets of paper with the images formed thereon. Here, printers 100 and 101 each have an image forming function of forming full color images using toners of the four colors of cyan, magenta, yellow, and black. Printers 100 and 101 are identical in terms of functions which they have, and therefore, printer 100 will be described representatively here.

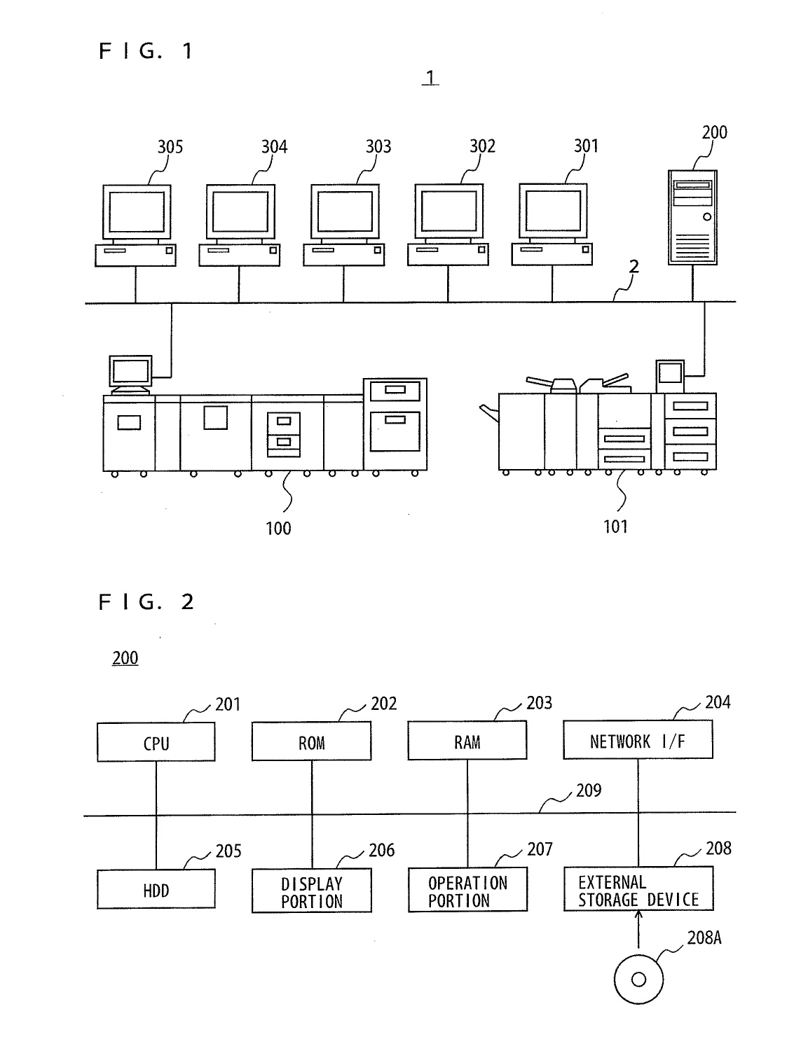

FIG. 2 is a block diagram showing an example of the hardware configuration of a server. Referring to FIG. 2, server 200 includes: a central processing unit (CPU) 201 which is responsible for overall control of server 200; a read only memory (ROM) 202; a random access memory (RAM) 203; a network interface (I/F) 204 for connecting server 200 to a network; a hard disk drive (HDD) 205 as a mass storage; a display portion 206; an operation portion 207 which accepts an input according to an operation by a user; and an external storage device 208.

ROM 202 stores a program executed by CPU 201 or data necessary for execution of the program. RAM 203 is used as a work area when CPU 201 executes a program.

Display portion 206 is a display such as a liquid crystal display (LCD) or an organic electro-luminescence display (ELD), and displays an instruction menu for the user, and others. Operation portion 207, which is provided with a plurality of keys, accepts input data such as instructions, characters, and numerical characters, according to the key operations by the user. Operation portion 207 may include a pointing device such as a mouse.

Network I/F 204 is an interface for connecting server 200 to network 2. CPU 201 transmits and receives data to and from PCs 301 to 305 and printers 100 and 101 via network I/F 204. Further, network I/F 204 is able to communicate with a PC connected to the Internet via network 2.

External storage device 208 is mounted with a removable recording medium such as a compact disk ROM (CD-ROM) 208A. CPU 201 is capable of accessing CD-ROM 208A mounted to external storage device 208. CPU 201 loads the program recorded on CD-ROM 208A mounted to external storage device 208, into RAM 203 for execution. It is noted that the program executed by CPU 201 is not restricted to the program recorded on CD-ROM 208A. CPU 201 may load a program stored in HDD 205, into RAM 203 for execution. In this case, another computer connected to network 2 may rewrite the program stored in HDD 205 of server 200, or may additionally write a new program therein. Further, server 200 may download a program from another computer connected to network 2, and store the program in HDD 205. As used herein, the “program” includes, not only the program which CPU 201 can execute directly, but also a source program, a compressed program, an encrypted program, and others.

It is noted that the recording medium for storing the program is not restricted to CD-ROM 208A. It may be a flexible disk, a cassette tape, an optical disc (magneto-optical (MO) disc, mini disc (MD), digital versatile disc (DVD)), an IC card (including a memory card), an optical card, or a semiconductor memory such as a mask ROM, an erasable programmable ROM (EPROM), an electrically erasable and programmable ROM (EEPROM), or the like.

In workflow system 1 according to the present embodiment, when an administrator receives a request from a customer, the administrator generates and registers a job ticket in server 200. More specifically, a salesperson receives document data from a customer and determines the editing contents in consultation with the customer. The salesperson generates a written directive for specifying the editing contents and the document data, to ask the administrator for execution of the processing. The written directive is stored in HDD 205 in server 200 as the salesperson inputs the same to server 200. The document data is stored in HDD 205 in server 200 as server 200 reads the same from a recording medium such as a memory card on which the document data is recorded, or as server 200 receives e-mail with the document data attached thereto.

The administrator generates a job ticket on the basis of the written directive and the document data stored in HDD 205 in server 200. Specifically, the administrator determines, on the basis of the written directive, two or more execution steps, from among a plurality of process steps, which are necessary for executing the content of the written directive, a process step order according to which the two or more execution steps are to be executed, and operators who will be in charge of the respective ones of the two or more execution steps. The administrator then inputs the execution steps, the process step order, the operators, and a delivery deadline to server 200, so that the generated job ticket is stored in HDD 205 in server 200. The job ticket defines, for each order from a customer, two or more execution steps, the process step order thereof, the operators who are in charge of the respective execution steps, and the delivery deadline.

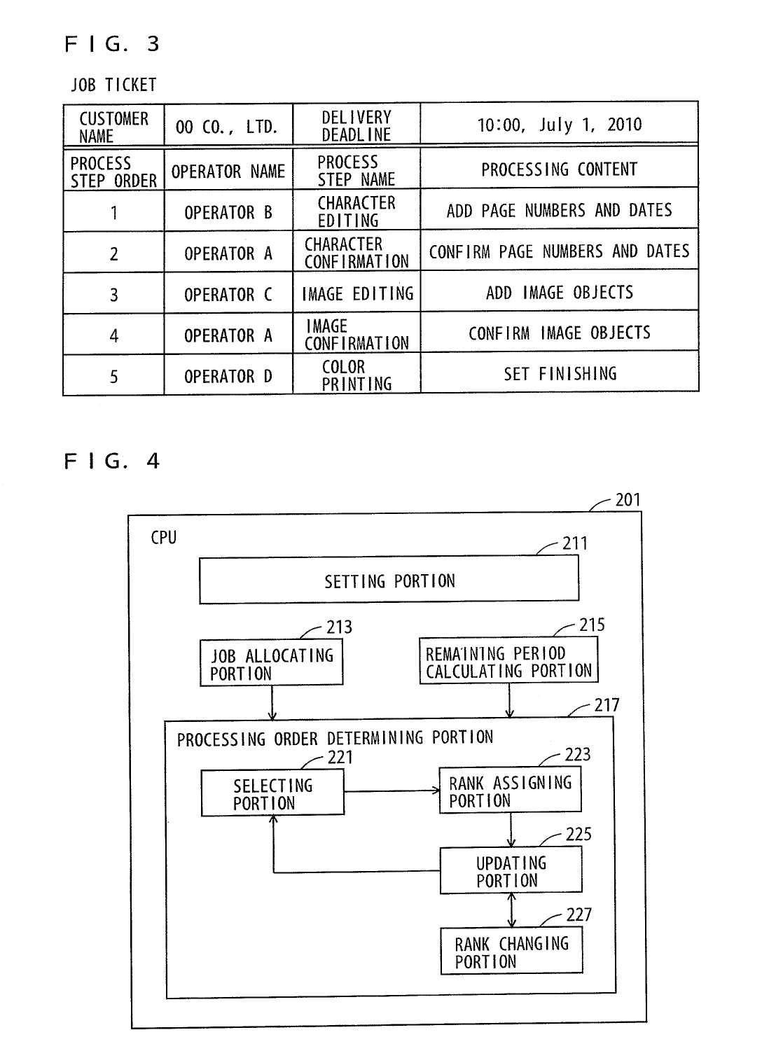

For more detailed explanation of a job ticket, it is here assumed that a written directive includes three types of editing contents of: “adding page numbers”, “adding dates”, and “adding image objects”. FIG. 3 shows an example of a job ticket. Referring to FIG. 3, a job ticket defines a customer name, a delivery deadline, and task content. The task content includes the fields of: “process step order”, “operator name”, “process step name”, and “processing content”.

The “process step order” field indicates the order in which a plurality of process steps are to be executed. In this example, the order of five process steps is defined. In the “operator name” field, identification information for identifying the operator who is in charge of the corresponding process step is set. In the “process step name” field, the name applied to the process to be executed by the operator in the corresponding process step is set. In the “processing content” field, the specific content of the process to be executed by the operator in that process step is set.

The job ticket shown in FIG. 3 indicates that an order has been received from a customer having the customer name of “00 Co., Ltd.”, and its delivery deadline is “10:00, Jul. 1, 2010”. The process step which is “1st” in the process step order and having the process step name “character editing” is assigned to the operator having the operator name “operator B”. The processing content of the process step with the process step name “character editing” includes a process of adding page numbers to the document data and a process of adding dates thereto. The process step which is “2nd” in the process step order and having the process step name “character confirmation” is assigned to the operator having the operator name “operator A”. The processing content of the process step with the process step name “character confirmation” includes confirmation of the page numbers and dates added to the document data, which is the process of checking the results of the processing in the preceding process step with the process step name “character editing”.

The process step which is “3rd” in the process step order and having the process step name “image editing” is assigned to the operator having the operator name “operator C”. The processing content of the process step with the process step name “image editing” includes a process of adding image objects to the document data. The process step which is “4th” in the process step order and having the process step name “image confirmation” is assigned to the operator having the operator name “operator A”. The processing content of the process step with the process step name “image confirmation” includes confirmation of the image objects added to the document data, which is the process of checking the results of the processing in the preceding process step with the process step name “image editing”. The process step which is “5th” in the process step order and having the process step name “color printing” is assigned to the operator having the operator name “operator D”. The processing content of the process step with the process step name “color printing” includes a process of setting finishing. The finishing indicates the way of bookbinding the sheets of paper on which the document data has been printed. The finishing setting includes, for example, setting of printing conditions including whether to form images on front sides, back sides, or both sides of sheets of paper, and whether to print in color or monochrome, and setting of post-processing conditions including whether to staple, and if so, the positions for stapling.

After a job ticket is stored in HDD 205, processes defined in the job ticket are carried out by operators. Here, processing that is defined in a job ticket is called a “job”. While a job ticket defines a plurality of processes in the respective process steps, the process steps are performed one after another in accordance with the process step order, and therefore, one job corresponds to one job ticket. When a job is executed, a mark “done” indicating that the processing has been executed is added to the job ticket in correspondence with the process step order and the process step name of the process step the job of which has been executed.

FIG. 4 is a block diagram schematically showing the function of the CPU included in the server. Referring to FIG. 4, CPU 201 includes: a setting portion 211 which accepts and stores job tickets; a job allocating portion 213 which allocates accepted jobs to a plurality of operators; a remaining period calculating portion 215 which calculates a remaining period; and a processing order determining portion 217 which determines the processing order for each of the plurality of operators.

On the basis of a written directive input by a salesperson to operation portion 207, an administrator inputs to operation portion 207 two or more execution steps among a plurality of process steps which are necessary for executing two or more processing contents defined in the written directive, the process step order according to which the two or more execution steps are to be executed, operators who will be in charge of the respective ones of the two or more execution steps, and the delivery deadline. Then, setting portion 211 accepts them, generates a job ticket including them, and stores the job ticket into HDD 205. HDD 205 stores therein document data associated with the written directive. Thus, setting portion 211 associates the job ticket with the document data that is stored in HDD 205 and associated with the written directive. Specifically, the administrator inputs, to operation portion 207, an operation of selecting one of a plurality of pieces of document data stored in HDD 205 so that the job ticket is associated with the selected piece of document data. Here, it is assumed that a plurality of sets of document data and job tickets have been accepted by setting portion 211 and, hence, those sets of document data and job tickets are stored in HDD 205.

As previously described, after a job ticket is stored in HDD 205, when a process is executed by an operator in accordance with the job ticket, the mark “done” indicating that the process has been executed is added to the job ticket in correspondence with the executed process step.

Job allocating portion 213 reads a plurality of job tickets stored in HDD 205 to allocate each of the read job tickets to an operator who is in charge of a first one of uncompleted process steps included therein. For example, in the job ticket shown in FIG. 3, assuming that the processes up to the “2nd” process step with the process step name “character confirmation” have been executed and, thus, the mark “done” is added in correspondence with the “1st” and “2nd” process steps, the first uncompleted process step is the “3rd” process step with the process step name “image editing”, and the operator name of the operator who is in charge of the first uncompleted process step is “operator C”. Hereinafter, a process which is carried out by an operator in accordance with a job ticket allocated to the operator by job allocating portion 213 will be referred to as a “process target job”. When job allocating portion 213 allocates a plurality of job tickets to a plurality of operators, the process target jobs are assigned to the respective operators. Job allocating portion 213 outputs the one or more job tickets allocated to each of the operators, to processing order determining portion 217.

Remaining period calculating portion 215 reads a plurality of job tickets stored in HDD 205, and calculates a remaining period for each of the job tickets, on the basis of a period up to the delivery deadline and an expected processing period which is a sum of the processing times for all the uncompleted process steps. Remaining period calculating portion 215 outputs the delivery deadline and the remaining period calculated for each of the job tickets, to processing order determining portion 217.

For example, in the job ticket shown in FIG. 3, assuming that the processes up to the “2nd” process step with the process step name “character confirmation” have been executed and, thus, the mark “done” is added in correspondence with the “1st” and “2nd” process steps, the uncompleted process steps are the “3rd” through “5th” process steps. In this case, a sum of the processing times for the uncompleted process steps with the process step names of “image editing”, “image confirmation”, and “color printing” is calculated as the expected processing period.

The processing time for each of the uncompleted process steps with the process step names of “image editing”, “image confirmation”, and “color printing” is calculated on the basis of a reference processing time that is predetermined for that process step and the document data that is associated with the job ticket. For example, the process to be performed in the process step with the process step name “image editing” is adding image objects to the respective pages included in the document data, so that the processing time increases with increasing number of pages in the document data. In the case where the reference processing time is set to be the time required for adding an image object to one page, then the processing time can be calculated by multiplying the reference processing time by the number of pages. The remaining period is calculated by subtracting the expected processing period from the time period from the current date and time to the delivery deadline defined in the job ticket.

Remaining period calculating portion 215 calculates, in addition to the remaining period for each of the job tickets, a takeover period and a return period for each of the job tickets. Remaining period calculating portion 215 outputs the takeover period and the return period calculated for each of the job tickets, to processing order determining portion 217.

The takeover period corresponds to a sum of the takeover time predetermined for each pair of consecutive process steps among all the uncompleted process steps defined in a job ticket. For example, in the job ticket shown in FIG. 3, assuming that the processes up to the “2nd” process step with the process step name “character confirmation” have been executed and, thus, the mark “done” is added in correspondence with the “1st” and “2nd” process steps, the uncompleted process steps are the “3rd” through “5th” process steps. In this case, the takeover time predetermined between the uncompleted process steps with the process step names “image editing” and “image confirmation” and the takeover time predetermined between the uncompleted process steps with the process step names “image confirmation” and “color printing” are summed to obtain the takeover period. It is noted that the takeover time may be predetermined between operators who are in charge of the respective ones of the consecutive process steps, instead of being predetermined between the process steps.

The return period corresponds to a total sum of the processing times of any defective process steps among all the uncompleted process steps defined in a job ticket. HDD 205 stores an occurrence probability table in advance. The defective process step refers to a process step that includes a process whose occurrence probability determined in the occurrence probability table is a prescribed threshold value or more. The return period may be configured to include the takeover period.

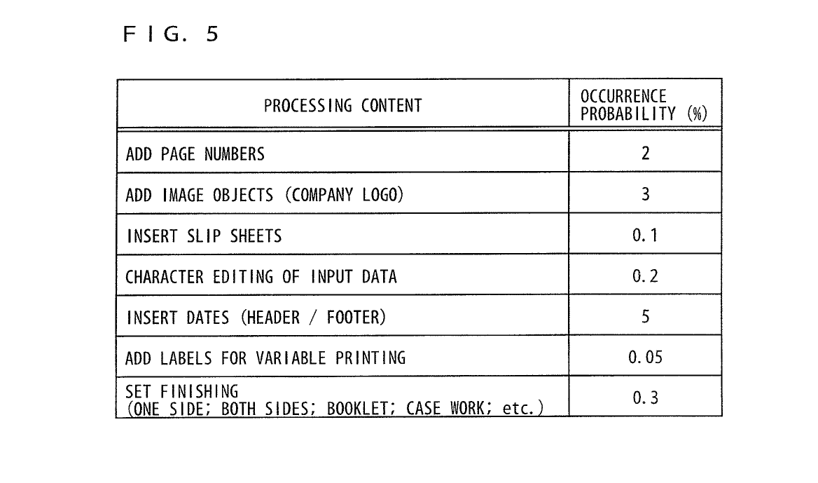

FIG. 5 shows an example of an occurrence probability table. Referring to FIG. 5, the occurrence probability table includes the fields of “processing content” and “occurrence probability”, and determines an occurrence probability for each of the processing contents. The occurrence probability indicates a ratio of the number of job tickets in which the process defined in the “processing content” field was executed twice to the number of job tickets in which the process defined in the “processing content” field was executed. In other words, the occurrence probability is a probability that, as a result of execution of the process defined in the “processing content” field, the process was not executed properly or rightly. The occurrence probability is updated whenever the process defined in the “processing content” field is executed and whenever the same is executed again.

For example, in the job ticket shown in FIG. 3, assuming that the processes up to the “2nd” process step with the process step name “character confirmation” have been executed and, thus, the mark “done” is added in correspondence with the “1st” and “2nd” process steps, the uncompleted process steps are the “3rd” through “5th” process steps. In this case, the processing content corresponding to the uncompleted process step with the process step name “image editing” is “adding image objects”, and the occurrence probability thereof is “3%”. For the processing content corresponding to the process step name “image confirmation”, an occurrence probability is not determined in the occurrence probability table. The processing content corresponding to the process step name “color printing” is “setting of finishing”, and the occurrence probability thereof is “0.3%”. Here, if a threshold value is set to 1%, of the uncompleted process steps with the process step names “image editing” and “color printing”, the process step with the process step name “image editing” corresponds to the defective process step. Accordingly, the processing time for the process step with the process step name “image editing” and the takeover period between the consecutive process steps with the process step names “image editing” and “image confirmation” are summed to obtain the return period.

Returning to FIG. 4, processing order determining portion 217 receives from job allocating portion 213 a plurality of job tickets allocated to a plurality of operators, and receives from remaining period calculating portion 215 the remaining period, the takeover period, and the return period for each of the plurality of job tickets.

Processing order determining portion 217 determines, for each operator, the order of one or more job tickets allocated to the operator among the plurality of job tickets. Specifically, processing order determining portion 217 sequentially selects one operator at a time from the operators, extracts one or more job tickets allocated to the selected operator as process targets, and determines the order of the one or more job tickets as the process targets.

The process for determining the processing order of one or more job tickets allocated to the respective operators is the same for each operator. Therefore, the case of determining the processing order of one or more job tickets allocated to a given operator will now be described by way of example.

Processing order determining portion 217 includes a selecting portion 221, a rank assigning portion 223, an updating portion 225, and a rank changing portion 227. Selecting portion 221 selects, from among one or more job tickets assigned to an operator, a job ticket which has not been ranked yet and which has the shortest remaining period corresponding thereto. In the case where there are two or more job tickets having the shortest remaining period, selecting portion 221 selects the one having a shorter return period in preference. Selecting portion 221 outputs the selected job ticket to rank assigning portion 223.

Rank assigning portion 223 assigns a rank, in ascending order from “1”, to each job ticket received from selecting portion 221. Rank assigning portion 223 outputs each set of the job ticket that has been assigned a rank and the rank assigned thereto, to updating portion 225.

Updating portion 225 temporarily stores in RAM 203 the remaining period of each of one or more outstanding job tickets which have not been ranked yet among the one or more job tickets allocated to the operator. Updating portion 225 also updates each of those remaining periods to a value obtained by subtracting therefrom the processing time (process step processing time) taken for processing the first uncompleted process step in the job ticket to which the rank has been assigned. Updating portion 225 outputs the updated remaining periods of the respective ones of the one or more outstanding job tickets which have not been ranked yet, to rank changing portion 227.

In the case where the one or more outstanding job tickets which have not been ranked yet include a job ticket whose updated remaining period takes a negative value, rank changing portion 227 assigns the same rank as the one that was lastly assigned by rank assigning portion 223, to the job ticket whose updated remaining period takes a negative value, and at the same time, cancels the rank of the job ticket to which rank assigning portion 223 lastly assigned the rank. In other words, the rank of the job ticket whose updated remaining period takes a negative value is moved up, while the rank of the job ticket that was assigned the rank lastly by rank assigning portion 223 is moved down. Hereinafter, the job ticket whose updated remaining period takes a negative value and the rank thereof has been moved up will be called the “moved-up job ticket”, and the job ticket that was assigned a rank lastly by rank assigning portion 223 and the rank thereof has been moved down will be called the “moved-down job ticket”. Rank changing portion 227 outputs an update instruction, including a pair of the moved-up job ticket and the rank assigned thereto and the moved-down job ticket, to updating portion 225.

When receiving an update instruction, updating portion 225 reads the remaining periods temporarily stored in RAM 203, and calculates the remaining periods again, in a similar manner as described above, by assigning the rank received from rank changing portion 227 to the moved-up job ticket included in the update instruction and by regarding the move-down job ticket included in the update instruction as a job ticket that has not been ranked yet. When receiving no update instruction from rank changing portion 227, updating portion 225 outputs the updated remaining periods to selecting portion 221.

Every time the updated remaining periods are input from updating portion 225, selecting portion 221 selects a job ticket whose updated remaining period is the shortest, among the one or more job tickets assigned to the operator, until there is no more job ticket yet to be ranked.

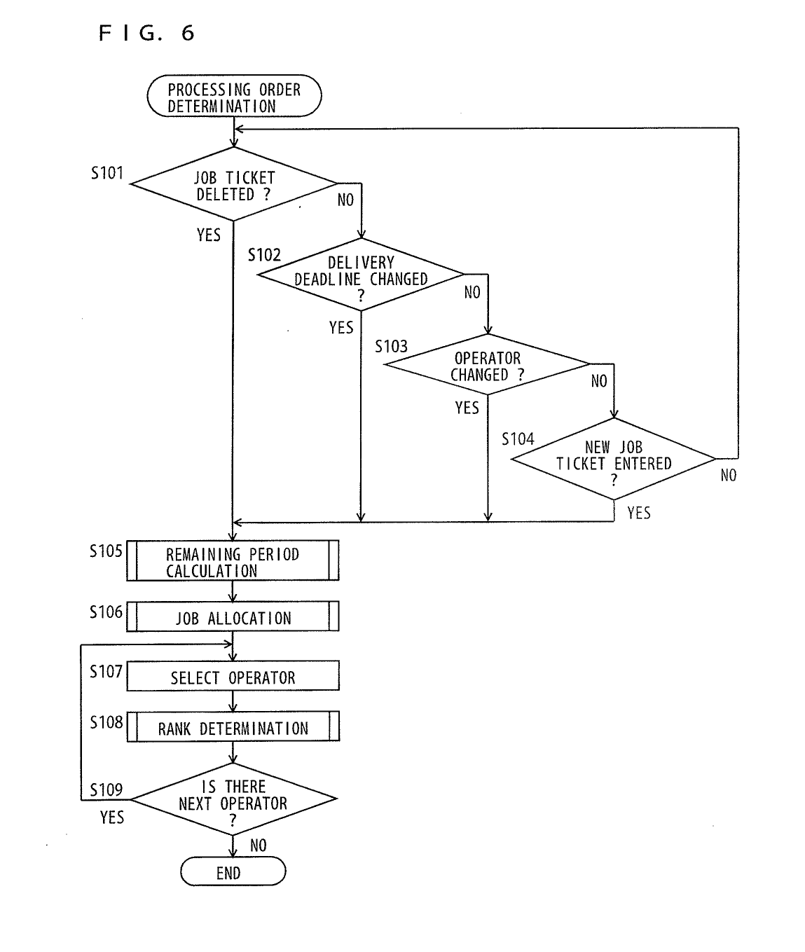

FIG. 6 is a flowchart illustrating an example of the flow of a processing order determining process. The processing order determining process is carried out by CPU 201 as CPU 201 executes a processing order determining program stored in ROM 202, HDD 205, or CD-ROM 208A. Referring to FIG. 6, CPU 201 determines whether any job ticket stored in HDD 205 has been deleted (step S101). Specifically, it is determined whether at least one of the job tickets stored in HDD 205 has been deleted. If so, the process proceeds to step S105; otherwise, the process proceeds to step S102.

In step S102, it is determined whether the delivery deadline of any of the job tickets stored in HDD 205 has been changed. If so, the process proceeds to step S105; otherwise, the process proceeds to step S103.

In step S103, it is determined whether the operator of any of the job tickets stored in HDD 205 has been changed. If so, the process proceeds to step S105; otherwise, the process proceeds to step S104.

In step S104, it is determined whether a new job ticket has been entered. When a new job ticket is stored in HDD 205, it is determined that a new job ticket has been entered. If so, the process proceeds to step S105; otherwise, the process returns to step S101.

In step S105, a remaining period calculating process is executed. The remaining period calculating process will be described later in detail. In the following step S106, a job allocating process is executed. The job allocating process, the details of which will be described later, is the process of allocating job tickets to operators. In the following step S107, an operator is selected. A rank determination process is then executed (step S108). In performing the rank determination process, the job tickets which have been allocated in step S106 to the operator selected in step S107 are set as the process targets. The rank determination process will be described later in detail. In the following step S109, it is determined whether there is another operator not yet selected in step S107. If there is any unselected operator, the process returns to step S107; otherwise, the process is terminated.

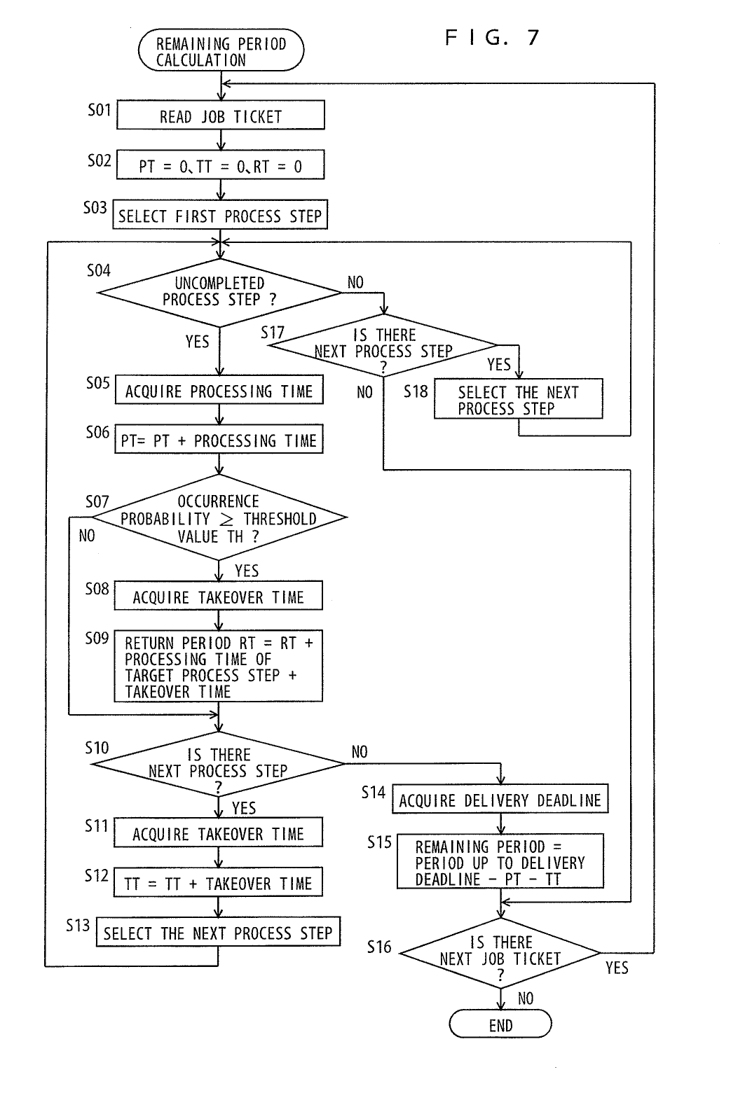

FIG. 7 is a flowchart illustrating an example of the flow of the remaining period calculation. The remaining period calculating process is executed in step S105 in FIG. 6. Referring to FIG. 7, CPU 201 reads a job ticket stored in HDD 205 (step S01). In the case where two or more job tickets are stored in HDD 205, CPU 201 selects and reads one of those job tickets that has not been set to a process target.

In the following step S02, variables PT, TT, and RT are each set to an initial value “0”. A sum of the processing times is set as variable PT, a sum of the takeover times is set as variable TT, and a sum of the return times is set as variable RT. In the following step S03, a first process step in the job ticket that has been set as the process target is selected. It is then determined whether the selected process step is an uncompleted process step (step S04). If the selected step is an uncompleted process step, the process proceeds to step S05; while if the selected process step has already been done, the process proceeds to step S17. In step S17, it is determined whether the job ticket defines a process step following the process step set as the process target. If so, the process proceeds to step S18; otherwise, the process proceeds to step S16. In step S18, the next process step is selected as a process target, and the process returns to step S04.

In step S05, the processing time for the process step selected as the process target is calculated. The processing time is calculated on the basis of the reference processing time predetermined for the process step selected as the process target and the document data to be processed. In the following step S06, variable PT is set to a value obtained by adding thereto the processing time calculated in step S05.

In the following step S07, it is determined whether the occurrence probability of the process included in the process step selected as the process target is a threshold value TH or more. The determination is made by referring to an occurrence probability table stored in advance in HDD 205. If the occurrence probability is equal to or greater than the threshold value TH, the process proceeds to step S08; otherwise, the process proceeds to step S10.

In step S08, a takeover time between the process step set as the process target and the succeeding process step is acquired. In the following step S09, variable RT is set to a value obtained by adding thereto the processing time for the process step that has been set as the process target and the takeover time acquired in step S08. The process then proceeds to step S10. In step S10, it is determined whether a process step following the process step that has been selected as the process target is defined in the job ticket. If so, the process proceeds to step S11; otherwise, the process proceeds to step S14.

In step S11, a takeover time between the process step being selected as the process target and the succeeding process step is acquired. In the following step S12, variable TT is set to a value obtained by adding thereto the takeover time acquired in step S11. In the following step S13, the next process step is selected as a process target, and the process returns to step S04.

In step S14, the delivery deadline defined in the job ticket being the process target is acquired. In the following step S15, a remaining period is calculated. Specifically, a value obtained by subtracting the processing period PT calculated in step S06 and the takeover period TT calculated in step S12 from the time period from the current time point to the delivery deadline acquired in step S14 is set as the remaining period.

In the following step S16, it is determined whether HDD 205 stores any job ticket that has not been read as a process target yet. If so, the process returns to step S01; otherwise, the process is terminated. In other words, the processes in steps S02 through S18 are carried out for all the job tickets stored in HDD 205. As a result, the remaining period, the return period, and the takeover period are calculated for each of all the job tickets stored in HDD 205.

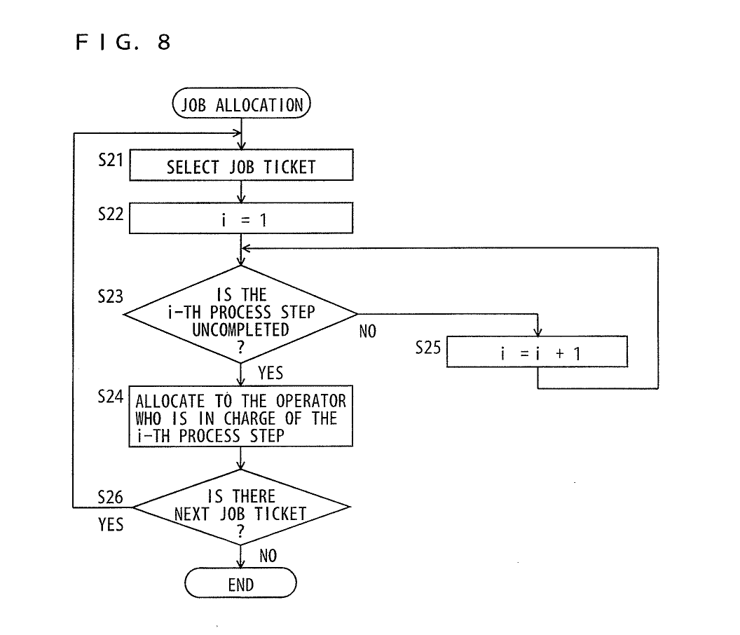

FIG. 8 is a flowchart illustrating an example of the flow of the job allocating process. The job allocating process is carried out in step S106 in FIG. 6. Referring to FIG. 8, CPU 201 selects one of the job tickets stored in HDD 205 (step S21). In the following step S22, CPU 201 sets a variable i to “1”. Variable i is for specifying the process step that is set as a process target. In the following step S23, it is determined whether the i-th process step is an uncompleted process step the processing of which has not been executed yet. If so, the process proceeds to step S24; otherwise, the process proceeds to step S25. In step S25, variable i is incremented by “1”, and the process returns to step S23. That is, a plurality of process steps defined in the job ticket are selected in ascending order of the process step order, and the process proceeds to step S24 only after a first uncompleted process step is found. In step S24, the job ticket is allocated to the operator who is in charge of the i-th process step, and the process proceeds to step S26.

In step S26, it is determined whether HDD 205 stores another job ticket that has not been read as a process target yet. If so, the process returns to step S21; otherwise, the process is terminated. In other words, all the job tickets stored in HDD 205 are each allocated to one of a plurality of operators.

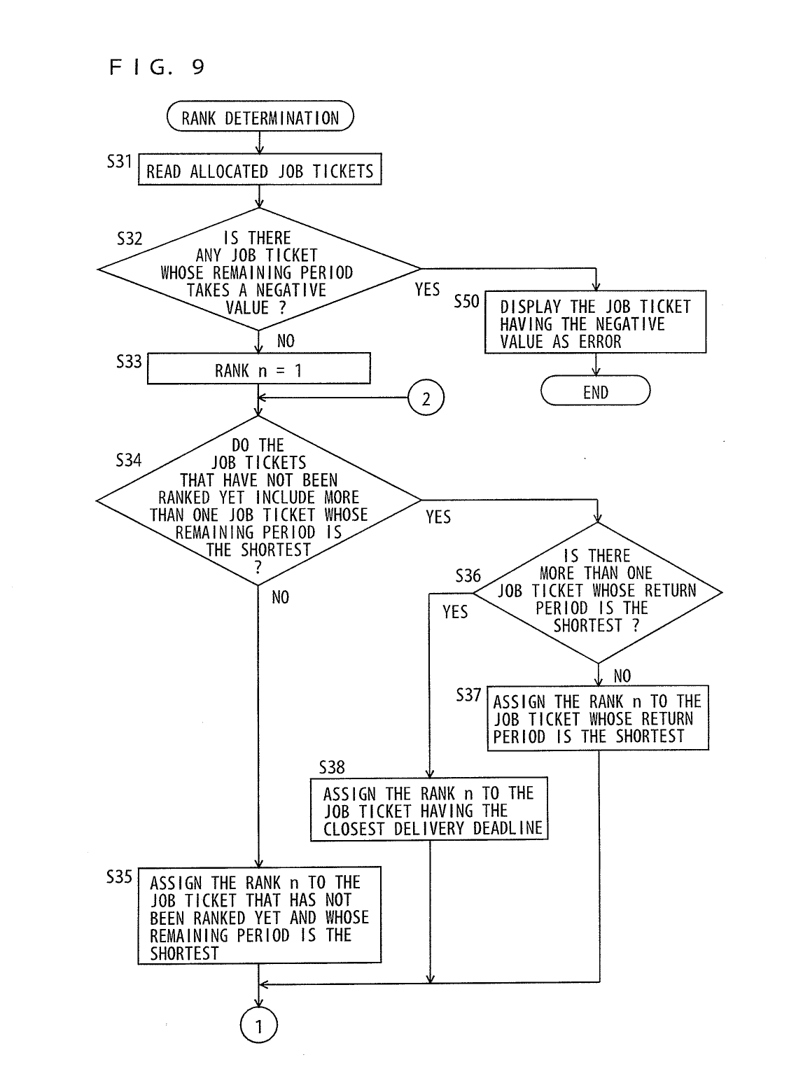

FIGS. 9 and 10 show a flowchart illustrating an example of the flow of the rank determination process. The rank determination process is carried out in step S108 in FIG. 6. Illustrated here is the flow of determining the order in which a given operator will deal with a plurality of job tickets allocated thereto. Referring to FIGS. 9 and 10, CPU 201 reads from HDD 205 all the job tickets allocated to a given operator (step S31). In the following step S32, it is determined whether there is a job ticket whose remaining period takes a negative value. If there is any, the process proceeds to step S50; otherwise, the process proceeds to step S33. In step S50, the job ticket whose remaining period takes a negative value is displayed on display portion 206 together with an error message, and the process is terminated. In this case, the job ticket whose remaining period takes a negative value cannot be processed to meet the delivery deadline with the current number of operators. It is necessary to increase the number of operators and, hence, to change the operator name in the corresponding field in the job ticket. Once the operator name is changed in the job ticket, it is determined YES in step S103 in FIG. 6, so that the processing order determining process is carried out again.

In step S33, a variable n indicating the rank is set to “1”. In the following step S34, it is determined whether the job tickets that have not been ranked yet include more than one job ticket whose remaining period is the shortest. If so, the process proceeds to step S36; otherwise, the process proceeds to step S35. In step S35, the job ticket that has not been ranked yet and whose remaining period is the shortest is assigned the rank n, and the process proceeds to step S39.

In step S36, it is determined whether there is more than one job ticket whose return period is the shortest. If the two or more job tickets whose remaining periods are the shortest include two or more job tickets whose return periods are the shortest, the process proceeds to step S38; whereas if they include one job ticket whose return period is the shortest, the process proceeds to step S37. In step S37, the job ticket whose return period is the shortest is assigned the rank n, and the process proceeds to step S39. In step S38, among the job tickets whose return periods are the shortest, the one whose delivery deadline is the closest to the current time is assigned the rank n, and the process proceeds to step S39.

In step S39, the remaining periods of the job tickets that have not been ranked yet are temporarily stored in RAM 203. In the following step S40, a processing time JPT for the job ticket of rank n is acquired. Specifically, the processing time for the process step that is defined in the job ticket as the process target and that is to be performed by the operator as the process target is acquired. In the following step S41, one of the job tickets that have not been ranked yet is selected. In the following step S42, the remaining period of the selected job ticket is set to a value obtained by subtracting therefrom the processing time JPT acquired in step S40. The process then proceeds to step S43. In step S43, it is determined whether the job tickets that have not been ranked yet include any job ticket that has not been selected as a process target. If so, the process returns to step S41; otherwise, the process proceeds to step S44. That is, in step S42, the remaining period of any job ticket that has not been ranked yet is updated to the value obtained by subtracting therefrom the processing time JPT for the job ticket that has been assigned the rank n in step S35, S37, or S38.

In step S44, it is determined whether there is any job ticket whose remaining period takes a negative value. If so, the process proceeds to step S45; otherwise, the process proceeds to step S48. In step S45, the rank of the job ticket that has been assigned the rank n is cancelled. Then, the rank n is assigned to the job ticket whose remaining period takes a negative value (step S46). In the following step S47, the remaining periods temporarily stored in RAM 203 in step S39 are read, and the remaining periods are returned to the values before being updated in step S42. The process then returns to step S40.

On the other hand, in step S48, it is determined whether there is another job ticket that has not been ranked yet. If so, the process proceeds to step S49; otherwise, the rank determination process is terminated. In step S49, variable n is incremented by “1”, and the process returns to step S34.

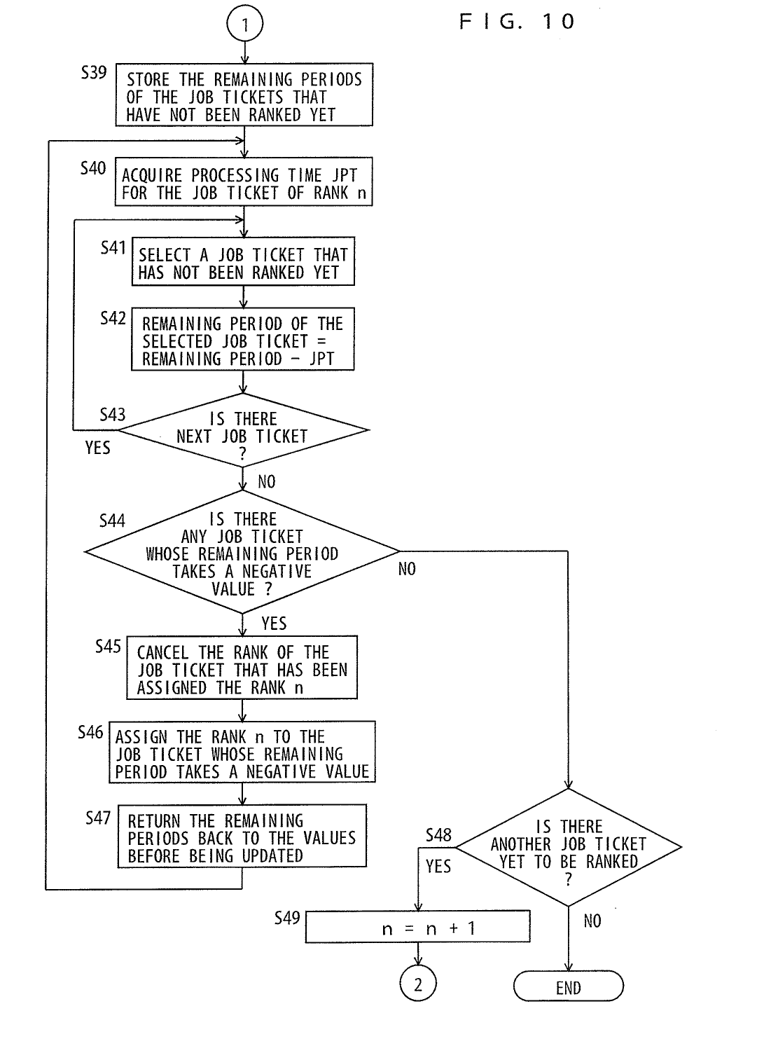

FIGS. 11A to 11C are a first set of diagrams illustrating how the ranks of job tickets are determined. FIGS. 11A to 11C show the procedure of determining ranks in the case where three job tickets “job A”, “job B”, and “job C” are stored in a certain process step. In FIGS. 11A to 11C, a delivery period, a processing order, a process step processing time, a processing period, a remaining period, and a return period are indicated for each of the job tickets “job A”, “job B”, and “job C”. The delivery period indicates the period from the current time to the delivery deadline. The processing order indicates the order in which the processing is to be executed. The process step processing time indicates the time necessary for an operator to carry out the processing of the corresponding process step. The processing period is a sum of the process step processing times for the uncompleted process steps included in each of the job tickets “job A”, “job B”, and “job C”. The remaining period is a value obtained by subtracting the processing period from the delivery period. When one of the job tickets “job A”, “job B”, and “job C” is assigned a rank, the remaining period of any job ticket that has not been ranked yet is updated to a value obtained by subtracting therefrom the process step processing time for the job ticket that has been assigned a rank. The return period is a sum of the process step processing times of any defective process steps if the uncompleted process steps include the defective process steps.

Referring to FIG. 11A, in the state where the processing order has not been set yet, the job ticket “job A” has the delivery period of “5.0 days”, the process step processing time of “0.2 days”, the processing period of “2.0 days”, and the return period of “1.0 day”, so that the remaining period is calculated to be “3.0 days”. The job ticket “job B” has the delivery period of “7.0 days”, the process step processing time of “0.5 days”, the processing period of “0.5 days”, and the return period of “0.0 day”, so that the remaining period is calculated to be “6.5 days”. The job ticket “job C” has the delivery period of “1.5 days”, the process step processing time of “0.3 days”, the processing period of “1.0 day”, and the return period of “0.0 day”, so that the remaining period is calculated to be “0.5 days”.

When the job tickets “job A”, “job B”, and “job C” as shown in FIG. 11A are input, firstly, the job ticket “job C” with the shortest remaining period is assigned rank “1” in the processing order.

FIG. 11B shows the remaining periods after the job ticket “job C” has been assigned rank “1”. In the job ticket “job A”, the remaining period “3.0 days” is reduced by the process step processing time of “0.3 days” as the job ticket “job C” is executed, resulting in the remaining period of “2.7 days”. Similarly, in the job ticket “job B”, the remaining period “6.5 days” is reduced by the process step processing time of “0.3 days” as the job ticket “job C” is executed, resulting in the remaining period of “6.2 days”. Accordingly, of the job tickets “job A” and “job B”, the job ticket “job A” with the shorter remaining period is assigned rank “2” in the processing order.

FIG. 11C shows the remaining periods after the job ticket “job A” has been assigned rank “2”. In the job ticket “job B”, the remaining period “6.2 days” is reduced by the process step processing time of “0.2 days” as the job ticket “job A” is executed, resulting in the remaining period of “6.0 days”. As the remaining period “6.0 days” of the job ticket “job B” is not a negative value, the job ticket “job B” is assigned rank “3” in the processing order.

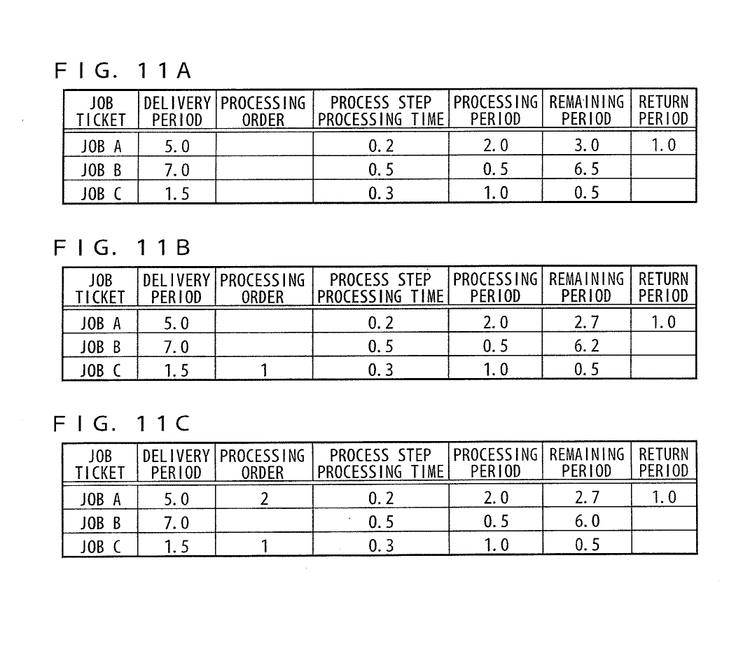

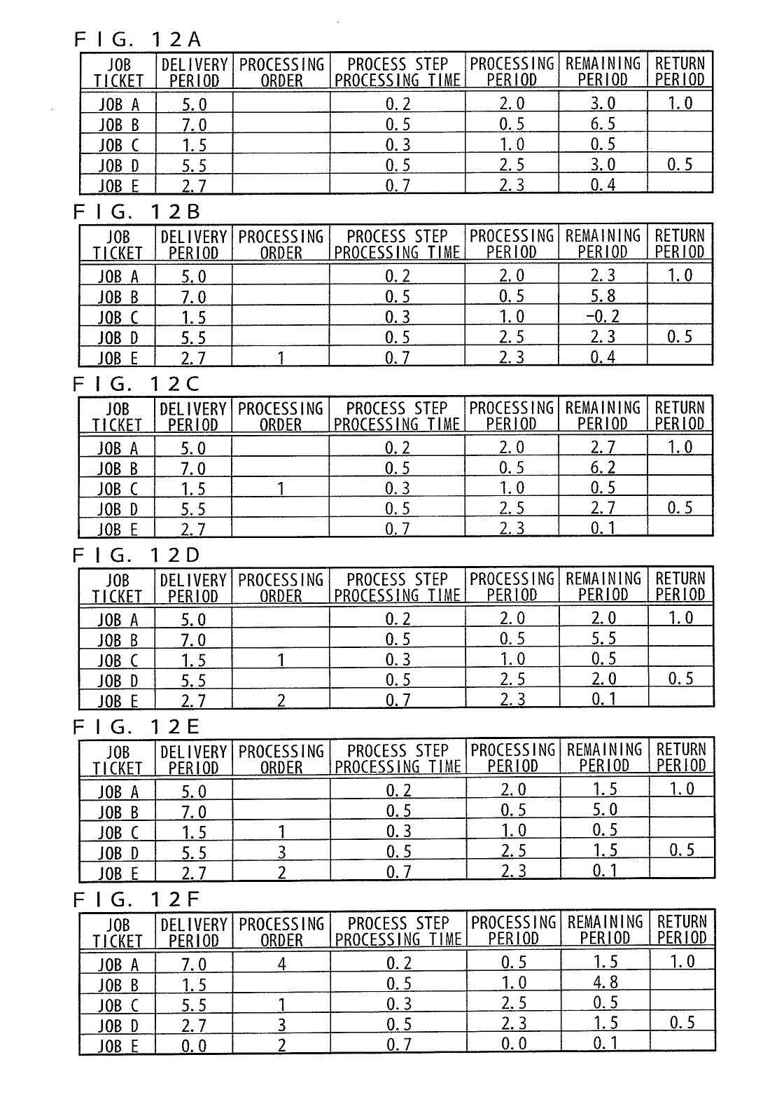

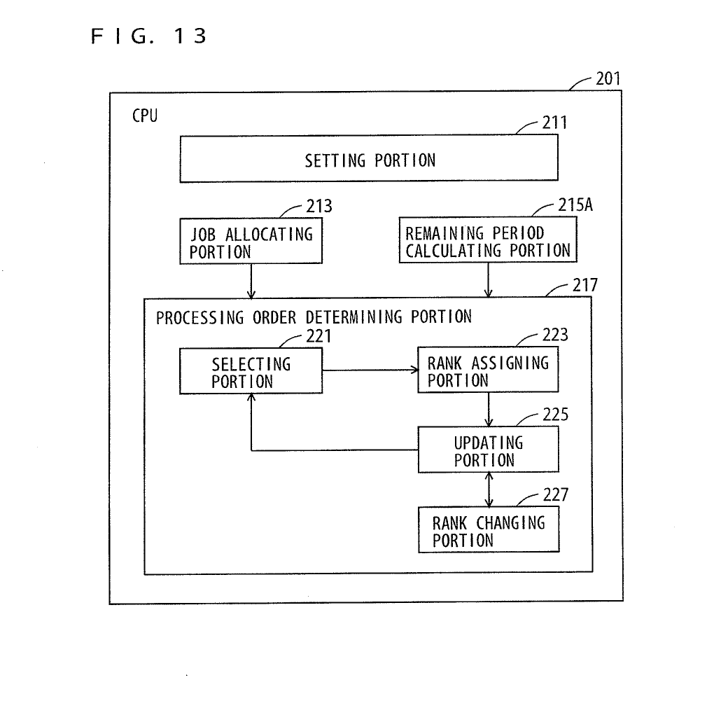

FIGS. 12A to 12F are a second set of diagrams illustrating how the ranks of job tickets are determined. FIGS. 12A to 12F show the case where two job tickets “job D” and “job E” are added after the three job tickets “job A”, “job B”, and “job C” shown in FIGS. 11A to 11C have been ranked. In this case, the ranks assigned to the job tickets “job A”, “job B”, and “job C” are cleared. In FIGS. 12A to 12F, the job tickets “job A”, “job B”, and “job C” each have the delivery period, the process step processing time, the processing period, and the return period identical to those shown in FIG. 11A.

Referring to FIG. 12A, in the state where the processing order has not been set yet, the remaining periods calculated for the job tickets “job A”, “job B”, and “job C” are identical to those shown in FIG. 11A. The job ticket “job D” has the delivery period of “5.5 days”, the process step processing time of “0.5 days”, the processing period of “2.5 days”, and the return period of “0.5 days”, so that the remaining period is calculated to be “3.0 days”. The job ticket “job E” has the delivery period of “2.7 days”, the process step processing time of “0.7 days”, the processing period of “2.3 days”, and the return period of “0.0 day”, so that the remaining period is calculated to be “0.4 days”. The job ticket “job E” has the shortest remaining period of “0.4 days”, and thus, the job ticket “job E” is assigned rank “1” in the processing order.

FIG. 12B shows the remaining periods after the job ticket “job E” has been assigned rank “1”. In the job ticket “job A”, the remaining period “3.0 days” is reduced by the process step processing time of “0.7 days” as the job ticket “job E” is executed, resulting in the remaining period of “2.3 days”.

Similarly, the remaining period for the job ticket “job B” becomes “5.8 days”, the remaining period for the job ticket “job C” becomes “−0.2 days”, and the remaining period for the job ticket “job D” becomes “2.3 days”. As the remaining period for the job ticket “job C” takes the negative value of “−0.2 days”, the rank “1” that has been assigned to the job ticket “job E” is cancelled, and the job ticket “job C” is assigned rank “1”.

FIG. 12C shows the remaining periods after the job ticket “job C” has been assigned rank “1”. In the job ticket “job A”, the remaining period “3.0 days” is reduced by the process step processing time of “0.3 days” as the job ticket “job C” is executed, resulting in the remaining period of “2.7 days”. Similarly, the remaining period for the job ticket “job B” becomes “6.2 days”, the remaining period for the job ticket “job D” becomes “2.7 days”, and the remaining period for the job ticket “job E” becomes “0.1 days”. Accordingly, of the job tickets “job A”, “job B”, “job D”, and “job E” that have not been ranked yet, the job ticket “job E” with the shortest remaining period is assigned rank “2” in the processing order.

FIG. 12D shows the remaining periods after the job ticket “job E” has been assigned rank “2”. In the job ticket “job A”, the remaining period “2.7 days” is reduced by the process step processing time of “0.7 days” as the job ticket “job E” is executed, resulting in the remaining period of “2.0 days”. Similarly, the remaining period for the job ticket “job B” becomes “5.5 days”, and the remaining period for the job ticket “job D” becomes “2.0 days”. Of the job tickets “job A”, “job B”, and “job D” that have not been ranked yet, the job tickets “job A” and “job D” each have the shortest remaining period. In this case, the job ticket “job D” with the shorter return period is assigned rank “3” in the processing order.

FIG. 12E shows the remaining periods after the job ticket “job D” has been assigned rank “3”. In the job ticket “job A”, the remaining period “2.0 days” is reduced by the process step processing time of “0.5 days” as the job ticket “job D” is executed, resulting in the remaining period of “1.5 days”. Similarly, the remaining period for the job ticket “job B” becomes “5.0 days”. Of the job tickets “job A” and “job B” that have not been ranked yet, the job ticket “job A” has the shorter remaining period, and thus, the job ticket “job A” is assigned rank “4” in the processing order.

FIG. 12F shows the remaining periods after the job ticket “job A” has been assigned rank “4”. In the job ticket “job B”, the remaining period “5.0 days” is reduced by the process step processing time of “0.2 days” as the job ticket “job A” is executed, resulting in the remaining period of “4.8 days”. As the remaining period “4.8 days” for the job ticket “job B” is not a negative value, the job ticket “job B” is assigned rank “5” in the processing order.

As described above, server 200 serving as the processing order determining apparatus calculates the remaining period for each of a plurality of job tickets, on the basis of the period up to the delivery deadline and the expected processing period. For one or more job tickets having their first uncompleted process steps to be done by a same operator, the ranks thereof are determined in ascending order of the remaining periods. In determining the ranks, a job ticket that has not been ranked yet and whose remaining period calculated is the shortest is assigned a rank. Then, the remaining period of each of the one or more outstanding job tickets that have not been ranked yet is updated to a value obtained by subtracting therefrom the processing times necessary for processing all job tickets that have been assigned ranks. In the case where there is a job ticket whose remaining period updated takes a negative value, the same rank as the one that was previously assigned to the job ticket is assigned to the job ticket whose remaining period takes a negative value, and the rank of the job ticket that was previously assigned the rank is cancelled. Accordingly, there will be no job ticket whose remaining period takes a negative value, thereby permitting determination of the processing order according to which the jobs are able to be done by the delivery deadlines.

In the case where there are two or more job tickets having the equal shortest remaining period, the rank is assigned in preference to the job ticket that includes in the uncompleted process steps a defective process step the processing of which would be highly likely repeated. This raises the probability that the processing can be done by the delivery deadline even if the processing is actually repeated.

Further, the remaining period is set to a value obtained by subtracting the expected processing period and the takeover period from the period up to the delivery deadline. This enables the remaining period to take a value close to that in the actual processing.

The processing order is determined when a new job ticket is added, when a job ticket is deleted, when an operator is changed, or when the delivery deadline of a job ticket is changed. This permits a plurality of jobs to be carried out by the delivery deadlines in accordance with the changes.

<Modification>

In server 200 functioning as the processing order determining apparatus in the above-described embodiment, remaining period calculating portion 215 calculates the remaining period by subtracting the expected processing period from the period that extends from the current date and time to the delivery deadline defined in the job ticket. In server 200 according to a modification, the remaining period is calculated by doubling the processing time for a defective process step which has the occurrence probability of a prescribed value or more.

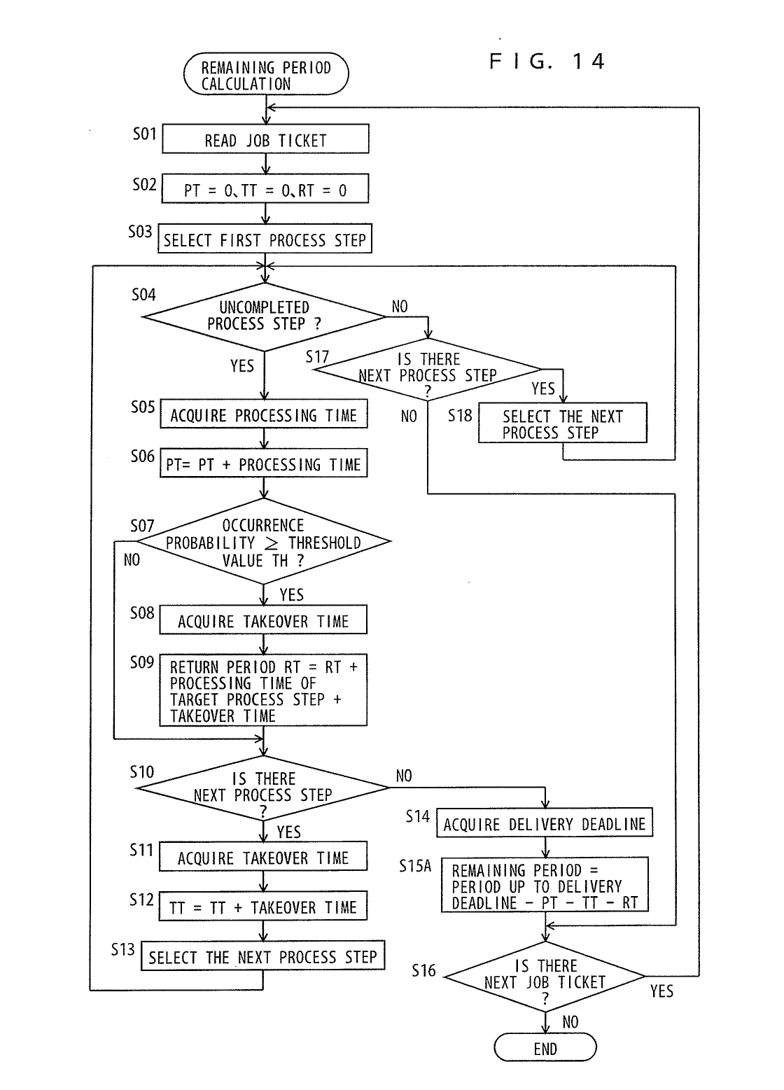

FIG. 13 is a block diagram schematically showing the functions of the CPU included in the server according to the modification. The block diagram in FIG. 13 is identical to that shown in FIG. 4 except that remaining period calculating portion 215 has been changed to a remaining period calculating portion 215A. The other functions are identical to those shown in FIG. 4, and thus, description thereof will not be repeated. Referring to FIG. 13, remaining period calculating portion 215A of the modification, as in remaining period calculating portion 215 shown in FIG. 4, reads a plurality of job tickets stored in HDD 205 to calculate, for each of the job tickets, a period up to the delivery deadline, an expected processing period which is a sum of the processing times for all the uncompleted process steps, a takeover period, and a return period. Remaining period calculating portion 215A sets a value obtained by subtracting the expected processing period, the takeover period, and the return period from the period up to the delivery deadline as a remaining period. This means that, for the defective process step whose occurrence probability is a prescribed value or more, the processing time for that defective process step is subtracted twice from the period up to the delivery deadline. Remaining period calculating portion 215A outputs the remaining period, the takeover period, and the return period calculated for each of the job tickets, as well as their delivery deadlines, to processing order determining portion 217.

FIG. 14 is a flowchart illustrating an example of the flow of the remaining period calculation according to the modification. The remaining period calculating process shown in FIG. 14 is identical to that shown in FIG. 7 except that step S15 has been changed to step S15A. The other processes are identical to those in FIG. 7, and thus, description thereof will not be repeated. In step S15A, a remaining period is calculated. Specifically, the processing period PT calculated in step S06, the takeover period TT calculated in step S12, and the return period RT calculated in step S09 are subtracted from the period from the current time to the delivery deadline acquired in step S14, to set the resultant value as the remaining period.

According to server 200 of the modification, for the defective process step having the occurrence probability of a prescribed value or more, the processing time for that defective process step is subtracted twice from the period up to the delivery deadline, to obtain the remaining period. That is, the processing order is determined assuming that the processing of the defective process step will be executed two times. Accordingly, the processing order can be determined such that, in the case where operators actually execute processing in accordance with the job tickets, even if the processing is executed twice for the defective process step, the jobs are able to be done by the delivery deadlines.

While server 200 has been described as an example of the processing order determining apparatus in the above embodiment, the present invention may of course be understood as a processing order determining method for performing the processing order determining process shown in FIG. 6 to 10 or 14, or as a processing order determining program for causing a computer to perform the processing order determining method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A processing order determining apparatus for managing delivery deadlines of a plurality of jobs, comprising:
a setting portion to set, for each of said plurality of jobs, two or more process steps selected from among a plurality of process steps, a process step order according to which said two or more process steps are to be executed, operators who are in charge of the respective ones of said two or more process steps, and a delivery deadline;
a remaining period calculating portion to calculate a remaining period for each of said plurality of jobs, on the basis of a period up to the delivery deadline and an expected processing period, the expected processing period being a sum of processing times for uncompleted process steps included therein;
a job allocating portion to allocate each of said plurality of jobs to an operator who is in charge of a first uncompleted process step included therein; and
a processing order determining portion to determine, for each of a plurality of operators, the order of one or more process target jobs, among said plurality of jobs, in each of which the operator is in charge of a first uncompleted process step included therein, the order being set in ascending order of the remaining period calculated for each of said one or more process target jobs,
said processing order determining portion including
a selecting portion to select, from among said one or more process target jobs, a process target job which has not been assigned a rank yet and for which said calculated remaining period is the shortest,
a rank assigning portion to assign a rank to said selected process target job,
an updating portion to update the remaining period of each of one or more outstanding process target jobs which have not been assigned ranks yet among said one or more process target jobs, to a value obtained by subtracting therefrom a process step processing time for the process step which is included in the process target job that has been assigned the rank and which is to be performed by said operator, and
a rank changing portion, in the case where the one or more outstanding process target jobs that have not been assigned ranks yet include a process target job whose remaining period that has been updated by said updating portion takes a negative value, to assign the same rank as the one that had been assigned to said selected process target job to the process target job whose remaining period takes a negative value, and to cancel the rank that had been assigned to said selected process target job.

2. The processing order determining apparatus according to claim 1, wherein in the case where there is more than one process target job for which said calculated remaining period is the shortest, said selecting portion selects, from said process target jobs whose remaining periods calculated are the shortest, the process target job which is the smallest in terms of a total sum of processing times for any defective process steps, the defective process step being a process step whose occurrence probability that the processing thereof will be repeated is a prescribed value or more.

3. The processing order determining apparatus according to claim 1, wherein said remaining period calculating portion calculates said remaining period on the basis of, in addition to said period up to the delivery deadline and said expected processing period, a sum of a takeover time necessary for a job to be taken over between each pair of process steps among said plurality of process steps.

4. The processing order determining apparatus according to claim 1, wherein said processing order determining portion determines the order in the case where the one or more process target jobs, among said plurality of jobs, allocated to an operator by said job allocating portion have been changed.

5. The processing order determining apparatus according to claim 4, wherein in the case where any of the one or more process target jobs allocated to an operator by said job allocating portion has been deleted or changed, or in the case where a new process target job has been added, said processing order determining portion determines that said one or more process target jobs have been changed.

6. A processing order determining apparatus for managing delivery deadlines of a plurality of jobs, comprising:
a setting portion to set, for each of said plurality of jobs, two or more process steps selected from among a plurality of process steps, a process step order according to which said two or more process steps are to be executed, operators who are in charge of the respective ones of said two or more process steps, and a delivery deadline;
a remaining period calculating portion to calculate a remaining period for each of said plurality of jobs, on the basis of a period up to the delivery deadline and an expected processing period, the expected processing period being a sum of processing times for uncompleted process steps included therein;
a job allocating portion to allocate each of said plurality of jobs to an operator who is in charge of a first uncompleted process step included therein; and
a processing order determining portion to determine, for each operator, the order of one or more process target jobs, among said plurality of jobs, in each of which the operator is in charge of a first uncompleted process step included therein, the order being set in ascending order of the remaining period calculated for each of said one or more process target jobs;
said remaining period calculating portion calculating said remaining period by doubling a processing time for any defective process step for which an occurrence probability that the processing thereof will be repeated is a prescribed value or more.

7. The processing order determining apparatus according to claim 6, wherein said processing order determining portion includes
a selecting portion to select, from among said one or more process target jobs, a process target job which has not been assigned a rank yet and for which said calculated remaining period is the shortest,
a rank assigning portion to assign a rank to said selected process target job,
an updating portion to update the remaining period of each of one or more outstanding process target jobs which have not been assigned ranks yet among said one or more process target jobs, to a value obtained by subtracting therefrom a process step processing time for the process step which is included in the process target job that has been assigned the rank and which is to be performed by said operator, and
a rank changing portion, in the case where said one or more outstanding process target jobs that have not been assigned ranks yet include a process target job whose remaining period that has been updated by said updating portion takes a negative value, to assign the same rank as the one that had been assigned to said selected process target job to the process target job whose remaining period takes a negative value, and to cancel the rank that had been assigned to said selected process target job.

8. A processing order determining method performed by a computer configured to manage delivery deadlines of a plurality of jobs, the method causing said computer to perform steps of:
setting, for each of said plurality of jobs, two or more process steps selected from among a plurality of process steps, a process step order according to which said two or more process steps are to be executed, operators who are in charge of the respective ones of said two or more process steps, and a delivery deadline;
calculating a remaining period for each of said plurality of jobs, on the basis of a period up to the delivery deadline and an expected processing period, the expected processing period being a sum of processing times for uncompleted process steps included therein;
allocating each of said plurality of jobs to an operator who is in charge of a first uncompleted process step included therein; and
determining, for each of a plurality of operators, the order of one or more process target jobs, among said plurality of jobs, in each of which the operator is in charge of a first uncompleted process step included therein, the order being set in ascending order of the remaining period calculated for each of said one or more process target jobs,
said determining step including steps of
selecting, from among said one or more process target jobs, a process target job which has not been assigned a rank yet and for which said calculated remaining period is the shortest,
assigning a rank to said selected process target job,
updating the remaining period of each of one or more outstanding process target jobs which have not been assigned ranks yet among said one or more process target jobs, to a value obtained by subtracting therefrom a process step processing time for the process step which is included in the process target job that has been assigned the rank and which is to be performed by said operator, and
in the case where the one or more outstanding process target jobs that have not been assigned ranks yet include a process target job whose remaining period that has been updated in said updating step takes a negative value, assigning the same rank as the one that had been assigned to said selected process target job to the process target job whose remaining period takes a negative value, and cancelling the rank that had been assigned to said selected process target job.

9. The processing order determining method according to claim 8, wherein said selecting step includes a step of, in the case where there is more than one process target job for which said calculated remaining period is the shortest, selecting, from said process target jobs whose remaining periods calculated are the shortest, the process target job which is the smallest in terms of a total sum of processing times for any defective process steps, the defective process step being a process step whose occurrence probability that the processing thereof will be repeated is a prescribed value or more.

10. The processing order determining method according to claim 8, wherein said remaining period calculating step includes a step of calculating said remaining period on the basis of, in addition to said period up to the delivery deadline and said expected processing period, a sum of a takeover time necessary for a job to be taken over between each pair of process steps among said plurality of process steps.

11. The processing order determining method according to claim 8, wherein said determining step includes a step of determining the order in the case where the one or more process target jobs, among said plurality of jobs, allocated to an operator in said allocating step have been changed.

12. The processing order determining method according to claim 11, wherein said determining step includes a step of determining that the one or more process target jobs allocated to an operator in said allocating step have been changed in the case where any of said one or more process target jobs allocated to the operator has been deleted or changed, or in the case where a new process target job has been added.

13. A processing order determining method performed by a computer configured to manage delivery deadlines of a plurality of jobs, the method causing said computer to perform steps of;
setting, for each of said plurality of jobs, two or more process steps selected from among a plurality of process steps, a process step order according to which said two or more process steps are to be executed, operators who are in charge of the respective ones of said two or more process steps, and a delivery deadline;
calculating a remaining period for each of said plurality of jobs, on the basis of a period up to the delivery deadline and an expected processing period, the expected processing period being a sum of processing times for uncompleted process steps included therein;
allocating each of said plurality of jobs to an operator who is in charge of a first uncompleted process step included therein; and
determining, for each operator, the order of one or more process target jobs, among said plurality of jobs, in each of which the operator is in charge of a first uncompleted process step included therein, the order being set in ascending order of the remaining period calculated for each of said one or more process target jobs;
said remaining period calculating step including a step of calculating said remaining period by doubling a processing time for any defective process step for which an occurrence probability that the processing thereof will be repeated is a prescribed value or more.

14. The processing order determining method according to claim 13, wherein said determining step includes steps of
selecting, from among said one or more process target jobs, a process target job which has not been assigned a rank yet and for which said calculated remaining period is the shortest,
assigning a rank to said selected process target job,
updating the remaining period of each of one or more outstanding process target jobs which have not been assigned ranks yet among said one or more process target jobs, to a value obtained by subtracting therefrom a process step processing time for the process step which is included in the process target job that has been assigned the rank and which is to be performed by said operator, and
in the case where said one or more outstanding process target jobs that have not been assigned ranks yet include a process target job whose remaining period that has been updated in said updating step takes a negative value, assigning the same rank as the one that had been assigned to said selected process target job to the process target job whose remaining period takes a negative value, and cancelling the rank that had been assigned to said selected process target job.

15. A non-transitory computer-readable recording medium encoded with a processing order determining program performed by a computer, the computer being configured to manage delivery deadlines of a plurality of jobs, the program causing said computer to execute processing comprising steps of:
setting, for each of said plurality of jobs, two or more process steps selected from among a plurality of process steps, a process step order according to which said two or more process steps are to be executed, operators who are in charge of the respective ones of said two or more process steps, and a delivery deadline;
calculating a remaining period for each of said plurality of jobs, on the basis of a period up to the delivery deadline and an expected processing period, the expected processing period being a sum of processing times for uncompleted process steps included therein;
allocating each of said plurality of jobs to an operator who is in charge of a first uncompleted process step included therein; and
determining, for each of a plurality of operators, the order of one or more process target jobs, among said plurality of jobs, in each of which the operator is in charge of a first uncompleted process step included therein, the order being set in ascending order of the remaining period calculated for each of said one or more process target jobs,
said determining step including steps of
selecting, from among said one or more process target jobs, a process target job which has not been assigned a rank yet and for which said calculated remaining period is the shortest,
assigning a rank to said selected process target job,
updating the remaining period of each of one or more outstanding process target jobs which have not been assigned ranks yet among said one or more process target jobs, to a value obtained by subtracting therefrom a process step processing time for the process step which is included in the process target job that has been assigned the rank and which is to be performed by said operator, and
in the case where the one or more outstanding process target jobs that have not been assigned ranks yet include a process target job whose remaining period that has been updated in said updating step takes a negative value, assigning the same rank as the one that had been assigned to said selected process target job to the process target job whose remaining period takes a negative value, and cancelling the rank that had been assigned to said selected process target job.

16. The non-transitory computer-readable recording medium encoded with the processing order determining program according to claim 15, wherein said selecting step includes a step of, in the case where there is more than one process target job for which said calculated remaining period is the shortest, selecting, from said process target jobs whose remaining periods calculated are the shortest, the process target job which is the smallest in terms of a total sum of processing times for any defective process steps, the defective process step being a process step whose occurrence probability that the processing thereof will be repeated is a prescribed value or more.

17. The non-transitory computer-readable recording medium encoded with the processing order determining program according to claim 15, wherein said remaining period calculating step includes a step of calculating said remaining period on the basis of, in addition to said period up to the delivery deadline and said expected processing period, a sum of a takeover time necessary for a job to be taken over between each pair of process steps among said plurality of process steps.

18. The non-transitory computer-readable recording medium encoded with the processing order determining program according to claim 15, wherein said determining step includes a step of determining the order in the case where the one or more process target jobs, among said plurality of jobs, allocated to an operator in said allocating step have been changed.

19. The non-transitory computer-readable recording medium encoded with the processing order determining program according to claim 18, wherein said determining step includes a step of determining that the one or more process target jobs allocated to an operator in said allocating step have been changed in the case where any of said one or more process target jobs allocated to the operator has been deleted or changed, or in the case where a new process target job has been added.

20. A non-transitory computer-readable recording medium encoded with a processing order determining program performed by a computer, the computer being configured to manage delivery deadlines of a plurality of jobs, the program causing said computer to execute processing comprising steps of;
setting, for each of said plurality of jobs, two or more process steps selected from among a plurality of process steps, a process step order according to which said two or more process steps are to be executed, operators who are in charge of the respective ones of said two or more process steps, and a delivery deadline;
calculating a remaining period for each of said plurality of jobs, on the basis of a period up to the delivery deadline and an expected processing period, the expected processing period being a sum of processing times for uncompleted process steps included therein;
allocating each of said plurality of jobs to an operator who is in charge of a first uncompleted process step included therein; and
determining, for each operator, the order of one or more process target jobs, among said plurality of jobs, in each of which the operator is in charge of a first uncompleted process step included therein, the order being set in ascending order of the remaining period calculated for each of said one or more process target jobs;
said remaining period calculating step including a step of calculating said remaining period by doubling a processing time for any defective process step for which an occurrence probability that the processing thereof will be repeated is a prescribed value or more.

21. The non-transitory computer-readable recording medium encoded with the processing order determining program according to claim 20, wherein said determining step includes steps of
selecting, from among said one or more process target jobs, a process target job which has not been assigned a rank yet and for which said calculated remaining period is the shortest,
assigning a rank to said selected process target job,
updating the remaining period of each of one or more outstanding process target jobs which have not been assigned ranks yet among said one or more process target jobs, to a value obtained by subtracting therefrom a process step processing time for the process step which is included in the process target job that has been assigned the rank and which is to be performed by said operator, and
in the case where said one or more outstanding process target jobs that have not been assigned ranks yet include a process target job whose remaining period that has been updated in said updating step takes a negative value, assigning the same rank as the one that had been assigned to said selected process target job to the process target job whose remaining period takes a negative value, and cancelling the rank that had been assigned to said selected process target job.
